(19) United States
(12) Patent Application Publication
(10) Pub. No.: US 2019/0048946 A1
(43) Pub. Date: Feb. 14, 2019

(54) FRICTION CLUTCH

(71) Applicant: Schaeffler Technologies AG & Co. KG, Herzogenaurach (DE)

(72) Inventors: Sebastian Heuberger, Bühl (DE); Christoph Raber, Ottweiler-Steinbach (DE); Martin Chambrion, Erstein (FR)

(73) Assignee: Schaeffler Technologies AG & Co. KG, Herzogenaurach (DE)

(21) Appl. No.: 16/078,984

(22) PCT Filed: Mar. 13, 2017
(86) PCT No.: PCT/DE2017/100197

§ 371 Date: Aug. 22, 2018

(30) Foreign Application Priority Data
Mar. 14, 2016 (DE) 10 2016 204 111.8

(51) Int. Cl. F16D 43/10; F16D 13/52; F16D 13/64; F16D 23/12; F16D 43/12

(52) U.S. Cl. CPC F16D 43/10; F16D 13/52; F16D 2023/123; F16D 23/12; F16D 43/12; F16D 13/648

(57) ABSTRACT

A friction clutch for a drivetrain of a motor vehicle includes an engine-side input part, a transmission-side output part, friction elements, an engine-side actuating device, and a transmission-side actuating device. The engine-side input part is disposed rotatably around an axis of rotation. The friction elements are arranged for frictionally engaging the engine-side input part to the transmission-side output part. The engine-side actuating device is arranged between the engine-side input part and the friction elements. The transmission-side actuating device is arranged between the transmission-side output part and the friction elements. At least one of the engine-side actuating device or the transmission-side actuating device is a centrifugal force controlled actuating device arranged to clamp the friction elements against one another.

### CROSS-REFERENCE TO RELATED APPLICATIONS

This application is the U.S. National Phase of PCT Appln. No. PCT/DE2017/100197 filed Mar. 13, 2017, which claims priority to German Application No. DE102016204111.8 filed Mar. 14, 2016, the entire disclosures of which are incorporated by reference herein.

### TECHNICAL FIELD

The disclosure relates to a friction clutch for a drivetrain of a motor vehicle, having an input part on the engine side, disposed rotatably around an axis of rotation, and an output part on the transmission side, connectible frictionally to the former by means of friction elements while forming a frictional engagement, the friction elements being designed to be clampable axially against one another by means of at least one actuating device controlled by centrifugal force.

### BACKGROUND

Friction clutches according to this species known as centrifugal clutches are known, which are disengaged when the centrifugal force of the friction clutch rotating around the axis of rotation is low, for example when an engine of the drivetrain is at idle speed, and which engage as the speed of rotation increases, and hence the centrifugal force increases. Such friction clutches are known, for example, from two-wheeled vehicles. Here, the friction clutch functions as a starting clutch, having an actuating device which engages and disengages depending on centrifugal force, positioned between the input part of the friction clutch and the friction elements, in that the friction elements are acted upon axially by means of centrifugal masses which are displaced radially along a ramp device. Such friction clutches may be combined with an automated transmission, for example a continuously variable transmission (CVT). Alternatively, a friction clutch according to this species—as known for example from WO 2015/135540 A1—may be employed, where the actuating device in the friction clutch, which operates depending on centrifugal force, serves as a moving-off element, and in addition a release mechanism operated by the driver is provided as an engaging and disengaging clutch, which disengages and engages the engaged frictional clutch against the centrifugal force.

In this case, the friction clutch, which is engaged by the actuating device operating dependent on centrifugal force, engages under centrifugal force at comparatively high speeds of the engine, so as to enable the provision of an appropriate start-up torque. As rotational speeds decrease, the friction clutch disengages at appropriately high speeds, so that at low rotational speeds above idle speed there is no longer any torque available from the engine while the motor vehicle is still moving.

### BRIEF SUMMARY

The proposed friction clutch is intended for a drivetrain of a motor vehicle. The friction clutch contains an input part on the engine side, disposed so that it can rotate about an axis of rotation, and an output part on the transmission side, connectible thereto frictionally by means of friction elements, forming a frictional engagement. To form a frictional engagement depending on the effect of centrifugal force, friction elements are assigned to the input part and the output part, which are designed so that they are clamp able axially against one another by means of at least one actuating device controlled by centrifugal force.

In particular to make it possible for the motor vehicle, for example two-wheel vehicles, to move off at a high rotational speed, and nevertheless to postpone disengagement due to centrifugal force at low rotational speeds, and thus, for example, to be able to drive in partial-load mode at low rotational speeds, an actuating device is provided on the engine side between the input part and the friction elements in an inherently normal manner, and in addition an actuating device on the transmission side between the output part and the friction elements. Both actuating devices apply an axial force to the friction elements to form a frictional engagement, depending on centrifugal force. This means that as the rotational speed of the input part increases and as the rotational speed of the output part increases, that is, with the vehicle moving, the friction clutch is engaged or remains engaged depending on centrifugal force, that is, depending on the rotational speeds of the engine and the transmission, and by derivation, of the drive wheel or wheels, until the friction clutch is disengaged again, for example at idle speed and with the motor vehicle essentially stopped. With the motor vehicle stopped, the friction clutch can therefore only be engaged at comparatively high rotational speeds, and thus when there is sufficient power for a rapid start. Because of the additional load on the friction elements by means of the actuating device on the transmission side with the motor vehicle in motion, the friction clutch remains engaged during the moving-off process until speeds below the clutch speed are reached, or it still transmits torque at least with slippage.

According to an example embodiment, the actuating devices may be connected parallel to one another. This means that the actuating devices are nested in one another, and exert a mutual axial force on the friction elements. In this case, one of the actuating devices, for example the actuating device on the transmission side, may act directly on the friction elements, while the other actuating device, for example the actuating device on the engine side, acts on the actuating device having the direct effect. In an alternative embodiment, the actuating devices may be connected in series with one another. This means that each of the actuating devices acts directly on the friction elements.

According to an example embodiment, an additional release mechanism operable by a driver may be provided to operate the clutch which is engaged under the effect of centrifugal force. This means that the actuating devices press the friction clutch closed under the effect of centrifugal force, and during the closed process, by means of the release mechanism, the torque transmitted by means of the friction clutch is interrupted, for example in order to undertake a shift procedure in the transmission. It goes without saying that the release mechanism may be actuated automatically, as an alternative to actuation by a driver, or may be provided with power-assist to assist the driver.

The proposed friction clutch may have the form of a dry-operated friction clutch, having a counter-pressure plate in an axially fixed position and a contact plate which is movable axially in relation thereto, which constitute the input-side friction elements, constituting the input part. The output-side friction elements are designed as friction linings of a clutch disk, which constitutes the output part of the friction clutch. The actuating devices, under the influence of centrifugal force, pre-stress the contact plate, forming a frictional engagement between the friction elements against the counter-pressure plate.

Alternatively, the proposed friction clutch may be operated wet, in which case the friction elements are made of alternately stacked laminae, which are pre-stressed against an axial stop by the actuating device, under the influence of centrifugal force. In this case, steel plates may be stacked alternately with friction plates and form a corresponding plate pack. For example, the friction plates may be joined non-rotatingly with an input-side plate carrier and the steel plates with an output-side plate carrier, such as hooked into them, which are pre-stressable axially by means of the actuating devices, depending on the centrifugal force.

According to an example embodiment, the plate pack of the friction clutch may be designed so that it can be pre-stressed by the actuating devices by means of a plate carrier which is movable axially relative to an axially fixed base plate, and rotary-coupled, depending on centrifugal force. In this case, each of the actuating devices may include two plate parts containing axially between them radially movable centrifugal masses, which form a ramp device, one of which plate parts is axially fixed and the other plate part axially movable, and the axially movable plate parts press the plate carrier axially against the base plate. To form a friction clutch which is forcibly engaged by the actuating clutch under the influence of centrifugal force, the axially movable plate parts of the ramp devices may be firmly connected axially in both directions to a plate carrier. The axially movable plate parts may however act on the plate carrier against the effect of at least one spring element, so that an equilibrium is operative between the pre-stressing of the spring element and the centrifugal force, so that the plate part engages the friction clutch against the effect of the spring element, under the influence of frictional force.

In a serial arrangement of the actuating devices, the axially movable plate parts may be arranged so that they are rotary-uncoupled against one another, with one of the plate parts, e.g., the plate part of the actuating device on the transmission side, acting axially on the plate carrier. In this case, the axially movable plate part of the actuating device on the engine side presses under the influence of centrifugal force, axially and rotary-uncoupled, for example by means of a needle bearing or the like, against the axially movable plate part of the actuating device on the transmission side, with an axial force which is redirected axially by the radially displaced centrifugal masses and the ramp device.

In an alternative embodiment, the two axially movable plate parts may act on the plate carrier directly, that is, axially in series.

The ramp devices may be formed by pre-stamped plate pieces having ramps running outward toward one another in a radial direction, between which centrifugal masses are provided, distributed axially around the circumference. The ramps may have a radial guideway along their extension. The centrifugal masses may be designed as rolling elements, such as balls, cylinders, sliding elements or the like.

### BRIEF DESCRIPTION OF THE DRAWINGS

The disclosure will be explained in further detail on the basis of the exemplary embodiment depicted in FIGS. 1 through 5. The figures show the following:

FIG. 1 is a sectional view through a friction clutch having two parallel actuating devices and a release device,

FIG. 2 is the friction clutch of FIG. 1 in 3D sectional view,

FIG. 3 is a partial section through a friction clutch modified in comparison to the friction clutches of FIGS. 1 and 2, with the actuating devices arranged in parallel,

FIG. 4 is a section through a friction clutch having two parallel actuating devices without a release device and

FIG. 5 is a diagram of the operating principle of the friction clutch of FIGS. 1 through 4.

### DETAILED DESCRIPTION

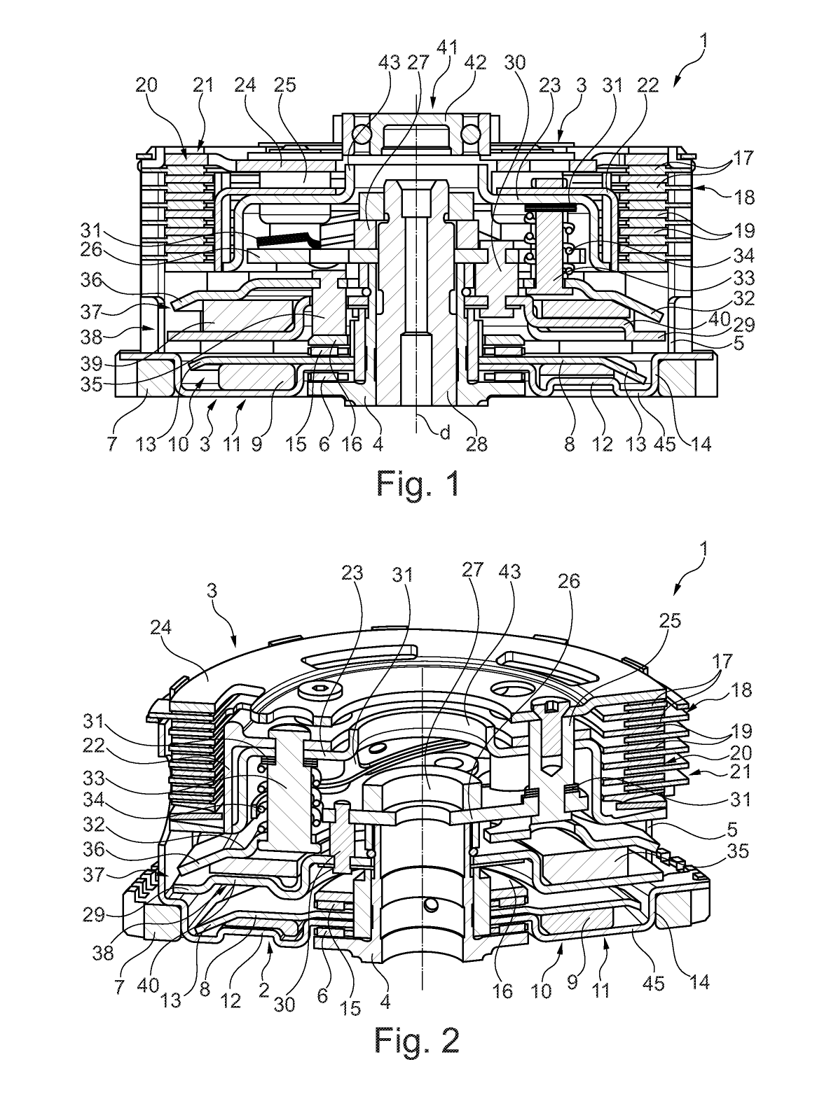

FIGS. 1 and 2 show, in sectional view and in 3D sectional depiction, an overview of the friction clutch 1 disposed rotatingly around the axis of rotation d, with the input part 2 and the output part 3. The input part 2 has the input-side plate carrier 5, supported on the hub piece 4 so that it is axially fixed and rotatable by means of the roller bearing 6 and thrust bearing; the plate carrier 5 is rotationally driven radially outside by means of the ring gear 7, for example by a primary drive of an engine. The plate carrier 5, as plate piece 45, with the plate piece 8 and the centrifugal masses 9 distributed around the circumference, forms the ramp device 10, which thereby forms the engine-side actuating device 11. By means of the stampings 12, the plate carrier 5 guides the centrifugal masses 9, fixed in the circumferential direction and radially movably. The plate piece 8 has ramps 13 running radially outside axially toward the radial extension of the plate carrier 5 which forms a plate extension or plate part, so that under the influence of the centrifugal force of the friction clutch 1 rotating about the axis of rotation d, the centrifugal masses are moved radially outward, and the plate piece 8 is moved axially while being braced axially on the plate carrier 5, which is braced axially on the hub piece 4. This results in an axial rise between a specified speed of rotation, for example the idle speed of the engine, and a limiting speed at which the centrifugal masses 9 are displaced radially by a maximum amount, for example coming to rest radially outside on the axial extension 14 of the plate carrier 5 which receives the ring gear 7. The rise is transmitted to the thrust ring 16, rotationally uncoupled, by means of the roller bearing 15.

The plate carrier 5 receives the friction elements 18 in the form of friction plates 17, rotationally fixed and axially movable to a limited extent. These, stacked alternating with the output-side friction elements 20 in the form of steel plates 19, form the plate pack 21.

The output part 3 is constructed as follows: The steel plates 19 are received radially inside on the plate carrier 22, for example hooked in, non-rotating and axially movable to a limited extent. The plate pack 21 is supported axially on the output-side base plate 24, and is acted on axially by the cup-shaped load transfer plate 23 connected to the plate carrier 22.

The base plate 24 receives the hub plate 26 firmly at an axial distance by means of the bolts 25 distributed around the circumference. The hub plate 26 is received firmly on the hub piece 4 by means of the thrust ring 27, and forms a rotationally locked connection with the transmission input shaft 28. The plate piece 29 is connected firmly to the hub plate 26 at an axial distance by means of the bolts 30 distributed around the circumference.

The plate carrier 22 is connected non-rotatingly and axially movably to the hub plate 26 by means of the leaf springs 31 distributed around the circumference, so that when a frictional engagement of the friction elements 18, 20 is formed, a torque introduced into the input part 2 is transmitted via the plate carrier 22 and the cup-shaped load transfer plate 23 to the hub plate 26, and thus to the transmission input shaft 28. The plate piece 32 is axially pre-stressed relative to the cup-shaped load transfer plate 23 by means of the bolts 33 distributed around the circumference and the spring elements 34—in this case helical compression springs. The axially fixed plate piece 29 and the plate piece 32, which is movable axially contrary to the effect of the spring elements 34, receive axially between them the centrifugal masses 35, which are distributed around the circumference and are radially movable. Radially outside, the plate piece 32 has the ramps 36 which run toward the plate piece 29. The plate piece 29 has stampings 40, which guide the centrifugal masses 35 fixedly in the circumferential direction and radially movably. These components form the ramp device 37, and the actuating device 38 on the transmission side. When the centrifugal force increases due to the speed of rotation, the centrifugal masses 35 are displaced radially outward, so that when the spring elements 34 and the leaf springs 31 are pre-stressed the cup-shaped load transfer plate 23 is moved axially and the frictional engagement of the friction elements 18, 20 is produced.

The coupling of the input-side actuating device 11 to the cup-shaped load transfer plate 23 occurs by means of the actuating device 38. The bolts 39 on the axially movable plate piece 32, distributed around the circumference and extending in the direction of the thrust ring 16, are provided for this purpose. When the actuating device 11 is actuated on the input side, the plate piece 8 moves the thrust ring 16 by means of the roller bearing 15, and thus the bolts 39. This moves the plate piece 32 axially, and the cup-shaped load transfer plate 23 acts on the plate pack 21.

During a driving-off process, in this way the actuating device 11 takes over pressing the plate pack against the base plate 24. As soon as the transmission input shaft 28 has reached a sufficient speed, the centrifugal masses 35 are accelerated radially outward, so that the contact pressure is intensified. A limitation of the contact pressure can be achieved through appropriate design of the spring elements 34, which give way under a specified overpressure. If the engine speed is reduced while the vehicle is moving, the pressing of the plate piece 8 decreases; however, the pressing and pre-stressing of the plate pack 21 is maintained as a result of the axial movement of the plate piece 32 and pre-stressing of the cup-shaped load transfer plate 23, until the motor vehicle has slowed below an appropriate velocity corresponding to a specified rotational speed of the transmission input shaft 28.

In addition to the actuating devices 11, 38, which press the friction clutch 1 into engagement depending on centrifugal force, the friction clutch 1 has the release mechanism 41, which enables disengagement of the friction clutch 1, which is engaged under centrifugal force. To this end, the release mechanism 41 has the release bearing 42, actuated in the axial direction by the driver or automatically, which moves the collar 43 of the cup-shaped load transfer plate 23 against the effect of the spring elements 34 and thereby breaks the frictional engagement between the friction elements 18, 20 brought about by the actuating devices 11, 38.

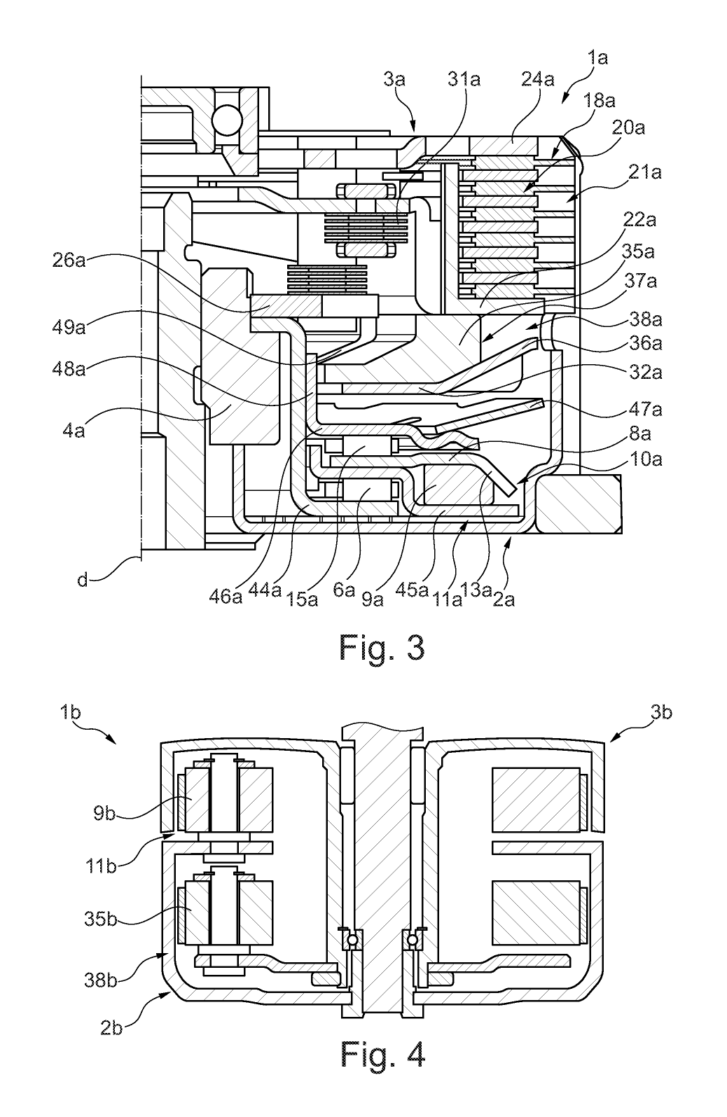

FIG. 3 shows, modifying the friction clutch 1 of FIGS. 1 and 2, the friction clutch 1a disposed around the axis of rotation d, in partial sectional view, with the input part 2a and the output part 3a. The engine-side and input-side actuating device 11a with the ramp device 10a, and the transmission-side and output-side actuating device 38a with the ramp device 37a, here act in series on the plate carrier 22a. To this end, the actuating device 38a has the plate piece 32a having the formed ramp 36a, braced axially opposite the plate piece 46a of the input-side actuating device 11a by means of the spring element 47a. Provided axially between the plate piece 32a and a seating surface of the plate carrier 22a are radially movable centrifugal masses 35a, distributed around the circumference, which are moved radially outward as the output part 3a rotates and thereby move the plate carrier 22a against the base plate 24a while tightening the plate pack 21a, and produce a frictional engagement of the friction elements 18a, 20a. Overpressing is avoided by means of the compression springs positioned between the base plate 24a and the plate carrier 22a, corresponding to the compression springs 34 of FIGS. 1 and 2.

The ramp device 10a of the actuating device 11 a includes the plate piece 44a, firmly connected to the hub piece 4a, which firmly braces the plate piece 45a of the ramp device 10a axially by means of the roller bearing 6a. The plate piece 8a with the ramp 13a is designed to be axially movable, and acts on the plate piece 46a, rotationally uncoupled, by means of the roller bearing 15a. Positioned between the plate pieces 8a, 45a are the radially movable centrifugal masses 9a, which are distributed around the circumference. The plate piece 46a is pre-stressed axially against the plate piece 32a by means of the spring element 47a—here a diaphragm spring. The plate piece 46a is slide-supported on the plate piece 44a by means of the axial extension 48a, and has arms 49a on its end which come to a stop against the hub plate 26a after the plate piece 46a has moved a specified distance. This limits the travel of the actuating device 11a, and brings about a pressure on the plate pack 21a due to centrifugal force, by means of an axially rigid connection through the plate piece 36a and the centrifugal masses 35a. If the output part 3a reaches a specified rotational speed, the centrifugal masses 35a move radially outward and pre-stress the plate pack 21a further. When the rotational speed at the input part 2a is reduced, for example by letting up on the gas to the engine, the plate piece moves back from the hub plate 26a, for example when the engine is idling; the plate pack 21a is pre-stressed by the actuating device 32a when the motor vehicle is moving, however.

FIG. 4 shows the friction clutch 1b in schematic sectional view, with the input part 2b and the output part 3b and the input-side and engine-side actuating device 11b and the output-side and transmission-side actuating device 38b. To form the actuating devices 11b, 38b, centrifugal masses 9b, 35b rotatably supported eccentrically on the input part 2b and output part 3b are included, which rotate under the centrifugal influence of the rotating input part 2b or output part 3b, and form a frictional engagement radially outside with an opposing friction surface of the other component—output part 3b or input part 2b. This achieves a frictional engagement between input part 2b and output part 3b under the influence of centrifugal force, both with input part 2b rotating and with output part 3b rotating.

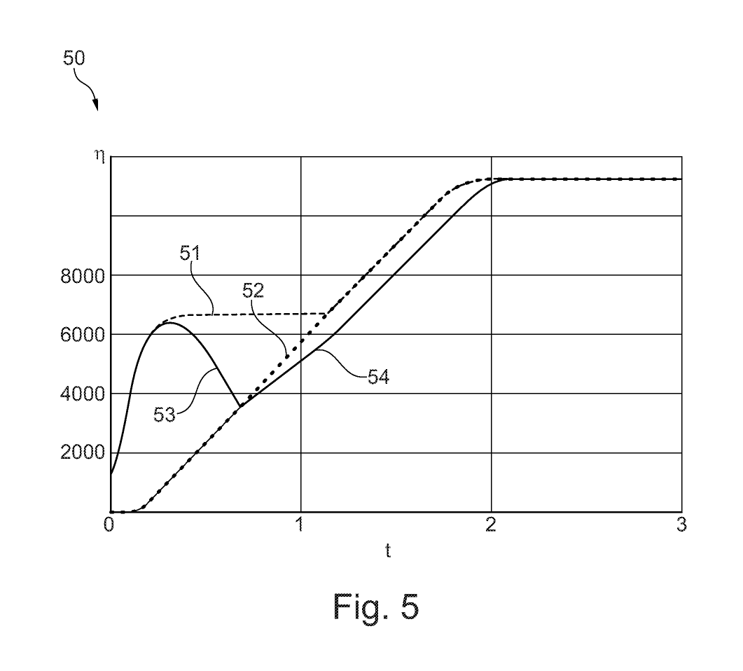

FIG. 5 shows diagram 50 of a simulation of a driving-off behavior of a motor vehicle of rotational speed n over time t, with a conventional friction clutch and the proposed friction clutch 1 of FIGS. 1 and 2. Curve 51 shows the speed of the engine and curve 52 the speed of the transmission with a conventional friction clutch. When driving off at 1500 rpm followed by full throttle, the speed of the engine is increased, and remains essentially constant as the friction clutch engages due to centrifugal force, up to the synchronization point at approximately 6700 rpm. Curve 53 shows the speed of the engine and curve 54 the speed of the transmission with the proposed friction clutch. Here, the engine is accelerated to a high speed, which causes the engine-side actuating device to be actuated due to centrifugal force, corresponding to curve 51. The transmission-side actuating device, which is likewise actuated as the motor vehicle begins to move, reduces the speed of the engine due to the higher load, and the synchronization point is reached at significantly lower speeds of around 3600 rpm. It can also be seen from diagram 50 that the effect of the transmission-side actuating device, as a result of which the speed of the engine is reduced, begins in the range of approximately 2000 rpm, so that at these speeds there is already a frictional engagement between input part and output part, even when the engine-side actuating device is inactive. It goes without saying that the synchronization points of the two actuating devices may be specified variably by appropriate selection of the centrifugal masses.

### LIST OF REFERENCE NUMERALS

1 friction clutch
1a friction clutch
1b friction clutch
2 input part
2a input part
2b input part
3 output part
3a output part
3b output part
4 hub part
4a hub part
5 plate carrier
6 roller bearing
6a roller bearing
7 ring gear
8 plate piece
8a plate piece
9 centrifugal mass
9a centrifugal mass
9b centrifugal mass
10 ramp device
10a ramp device
11 actuating device
11a actuating device
11b actuating device
12 stamping
13 ramp
13a ramp
14 extension
15 roller bearing
15a roller bearing
16 thrust ring
17 friction plate
18 friction element
18a friction element
19 steel plate
20 friction element
20a friction element
21 plate pack
21a plate pack
22 plate carrier
22a plate carrier
23 cup-shaped load transfer plate
24 base plate
24a base plate
25 bolt
26 hub plate
26a hub plate
27 thrust ring
28 transmission input shaft
29 plate piece
30 bolt
31 leaf spring
31a leaf spring
32 plate piece
32a plate piece
33 bolt
34 spring element
35 centrifugal mass
35a centrifugal mass
35b centrifugal mass
36 ramp
36a ramp
37 ramp device
37a ramp device
38 actuating device
38a actuating device
38b actuating device
39 bolt
40 stamping
41 release mechanism
42 release bearing
43 collar
44a plate piece
45 plate piece
45a plate piece
46a plate piece
47a spring element
48a extension
49a arm
50 diagram
51 curve
52 curve
53 curve
54 curve
d axis of rotation
n speed of rotation
t time

1-10. (canceled)

11. A friction clutch for a drivetrain of a motor vehicle comprising:
an engine-side input part disposed rotatably around an axis of rotation;
a transmission-side output part;
friction elements arranged for frictionally engaging the engine-side input part to the transmission-side output part;
an engine-side actuating device arranged between the engine-side input part and the friction elements; and,
a transmission-side actuating device arranged between the transmission-side output part and the friction elements, wherein:
at least one of the engine-side actuating device or the transmission-side actuating device is a centrifugal force controlled actuating device arranged to clamp the friction elements against one another.

12. The friction clutch of claim 11, wherein the engine-side actuating device and the transmission-side actuating device are connected in parallel.

13. The friction clutch of claim 11, wherein the engine-side actuating device and the transmission-side actuating device are connected in series.

14. The friction clutch of claim 11, further comprising a release mechanism, actuatable by a driver or automatically, to release the friction clutch.

15. The friction clutch of claim 11, wherein the friction elements comprise a plate pack with alternately stacked friction plates and steel plates that are axially pre-stressed by the engine-side actuating device or the transmission-side actuating device, depending on the centrifugal force.

16. The friction clutch of claim 15 further comprising:
an axially fixed base plate; and,
a cup-shaped load transfer plate, axially movable and rotationally coupled relative to the axially fixed base plate, for axially pre-stressing the friction plates and the steel plates.

17. The friction clutch of claim 15 further comprising:
an axially fixed base plate; and,
a plate carrier, axially movable and rotationally coupled relative to the axially fixed base plate, for axially pre-stressing the friction plates and the steel plates.

18. The friction clutch of claim 17, wherein the engine-side actuation device or the transmission-side actuation device comprises:
an axially fixed plate piece;
an axially movable plate piece; and,
a radially movable centrifugal mass disposed axially between the axially fixed plate piece and the axially movable plate piece, wherein:
the axially fixed plate piece and the axially movable plate piece are arranged to form a ramp device; and,
the axially movable plate piece acts on the plate carrier axially against the axially fixed base plate.

19. The friction clutch of claim 18 further comprising a resilient element, wherein:
the axially movable plate piece acts on the plate carrier against the resilient element; and,
the resilient element comprises a spring element or a leaf spring.

20. The friction clutch of claim 18 further comprising an output-side hub piece, wherein the axially fixed plate piece and the axially movable plate piece are rotatable relative to the output-side hub piece.

21. The friction clutch of claim 17, wherein:
the engine-side actuation device comprises:
an engine-side axially fixed plate piece;
an engine-side axially movable plate piece arranged with the engine-side axially fixed plate piece to form a ramp device; and,
an engine-side radially movable centrifugal mass disposed axially between the engine-side axially fixed plate piece and the engine-side axially movable plate piece;
the transmission-side actuation device comprises:
a transmission-side axially fixed plate piece;
a transmission-side axially movable plate piece arranged with the transmission-side axially fixed plate piece to form a ramp device; and,
a transmission-side radially movable centrifugal mass disposed axially between the transmission-side axially fixed plate piece and the transmission-side axially movable plate piece; and,
the engine-side axially movable plate piece acts on the plate pack through the transmission-side axially movable plate piece.

22. A friction clutch comprising:
an input-side arranged for driving connection with an engine;
an output-side arranged for driving connection with a transmission;
a clutch pack comprising a plurality of friction elements arranged to frictionally connect the input-side to the output-side;
an input-side centrifugal actuator arranged to clamp the clutch pack at a first engine speed; and,
an output-side centrifugal actuator arranged to clamp the clutch pack at a first transmission speed.

23. The friction clutch of claim 22 wherein the input-side centrifugal actuator or the output-side centrifugal actuator comprises:
a first plate;
a second plate arranged with the first plate to form a ramp element; and,
a radially displaceable centrifugal mass disposed axially between the first plate and the second plate.

24. The friction clutch of claim 22 further comprising a release mechanism arranged to overcome the input-side centrifugal actuator, the output-side centrifugal actuator, or both the input-side centrifugal actuator and the output-side centrifugal actuator to unclamp the clutch pack.
